(19) United States
(12) Patent Application Publication
(10) Pub. No.: US 2026/0260489 A1
(43) Pub. Date: Sep. 3, 2026

(54) SYSTEMS AND METHODS FOR MILESTONE DETECTION WITH A SPATIAL CONTEXT

(71) Applicant: INTUITIVE SURGICAL OPERATIONS, INC., Sunnyvale, CA (US)

(72) Inventors: Rui Guo, Suwanee, GA (US); Conor Perreault, Atlanta, GA (US); Xi Liu, Peachtree Corners, GA (US); Benjamin Mueller, Flowery Branch, GA (US); Sue Kulason, Brookhaven, GA (US); Ziheng Wang, Atlanta, GA (US); Anthony M. Jarc, Johns Creek, GA (US)

(21) Appl. No.: 19/165,013

(22) PCT Filed: Mar. 12, 2024
(86) PCT No.: PCT/US2024/019554

§ 371 Date: Sep. 12, 2025

Related U.S. Application Data
(60) Provisional application No. 63/489,937, filed on Mar. 13, 2023.

(51) Int. Cl. G06V 20/40; G06F 3/0482; G06V 10/82; G06V 20/52

(52) U.S. Cl. CPC G06V 20/41; G06F 3/0482; G06V 10/82; G06V 20/44; G06V 20/52

(57) ABSTRACT

A method for detecting procedure milestone events with a spatial context may comprise receiving a video input including a plurality of video frame images of a procedure and analyzing the video input using a neural network model that includes a multi-head attention mechanism. The method may also include generating, with a spatial context head of the multi-head attention mechanism, a spatial context indicator for at least a portion of the plurality of video frame images. The method may also include generating, with a classification head of the multi-head attention mechanism, a milestone indicator for at least one of the plurality of video frame images of the plurality of video frame images and generating a procedure evaluation output that includes the milestone indicator and the spatial context indicator.

### CROSS-REFERENCED APPLICATIONS

This application claims priority to and benefit of U.S. Provisional Applications No. 63/489,937 filed Mar. 13, 2023 and entitled “Systems and Methods for Milestone Detection with a Spatial Context,” which is incorporated by reference herein in its entirety.

### FIELD

Examples described herein relate generally to systems and method for analyzing a procedure using machine learning models and neural networks, and more specifically, to systems and methods for detecting procedure milestones with a spatial context.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Medical procedures conducted with the robot-assisted medical systems may be video recorded, allowing a clinician or a clinician trainer to review the performance of the procedure. Improved methods and systems for analyzing the recorded procedures, including the evaluation of milestones critical to a successful procedure outcome, are needed.

### SUMMARY

The following presents a simplified summary of various examples described herein and is not intended to identify key or critical elements or to delineate the scope of the claims.

Consistent with some examples, a method for detecting procedure milestone events with a spatial context may comprise receiving a video input including a plurality of video frame images of a procedure and analyzing the video input using a neural network model that includes a multi-head attention mechanism. The method may also include generating, with a spatial context head of the multi-head attention mechanism, a spatial context indicator for at least a portion of the plurality of video frame images. The method may also include generating, with a classification head of the multi-head attention mechanism, a milestone indicator for at least one of the plurality of video frame images of the plurality of video frame images and generating a procedure evaluation output that includes the milestone indicator and the spatial context indicator. Other examples include corresponding computer systems, apparatus, and computer programs recorded on one or more computer storage devices, each configured to perform the actions of any one or more methods described below.

In some examples, a system for detecting procedure milestone events with a spatial context may comprise a memory configured to store a neural network model and a processor coupled to the memory. The processor may be configured to receive a video input including a plurality of video frame images of a procedure and analyze the video input using a neural network model that includes a multi-head attention mechanism. The processor may also be configured to generate, with a spatial context head of the multi-head attention mechanism, a spatial context indicator for at least a portion of the plurality of video frame images and generate, with a classification head of the multi-head attention mechanism, a milestone indicator for at least one of the plurality of video frame images of the plurality of video frame images. The processor may also be configured to generate a procedure evaluation output that includes the milestone indicator and the spatial context indicator.

In some examples, a non-transitory machine-readable medium has stored thereon machine-readable instructions executable to cause a machine to perform operations that evaluate a procedure. The operations may comprise receiving a video input including a plurality of video frame images of the procedure and analyzing the video input using a neural network model that includes a multi-head attention mechanism. The operations may also comprise generating, with a spatial context head of the multi-head attention mechanism, a spatial context indicator for at least a portion of the plurality of video frame images and generating, with a classification head of the multi-head attention mechanism, a milestone indicator for at least one of the plurality of video frame images of the plurality of video frame images. The operations may also comprise generating a procedure evaluation output that includes the milestone indicator and the spatial context indicator.

It is to be understood that both the foregoing general description and the following detailed description are illustrative and explanatory in nature and are intended to provide an understanding of the various examples described herein without limiting the scope of the various examples described herein. In that regard, additional aspects, features, and advantages of the various examples described herein will be apparent to one skilled in the art from the following detailed description.

### BRIEF DESCRIPTIONS OF THE DRAWINGS

FIG. 1 is a flowchart illustrating a method for evaluating a procedure, according to some examples.

FIG. 2 illustrates a milestone detection workflow including a neural network model, according to some examples.

FIG. 3 illustrates a spatial context indicator at a milestone event, according to some examples.

FIG. 4 illustrates a user interface for displaying a procedure evaluation output, according to some examples.

FIG. 5 illustrates the user interface of FIG. 5 including a display portion for displaying a frame of a video input with a spatial indicator, according to some examples.

FIG. 6 illustrates the user interface of FIG. 5 including a display portion for displaying a frame of a video input with a spatial indicator, according to some examples.

FIG. 7A illustrates an image frame from of a video of a procedure, according to some examples.

FIG. 7B illustrates the image frame of FIG. 7A annotated to include a spatial context indicator at a milestone event of the procedure, according to some examples.

FIG. 8 illustrates a robot-assisted medical system, according to some examples.

Various examples described herein and their advantages are described in the detailed description that follows. It should be appreciated that like reference numerals are used to identify like elements illustrated in one or more of the figures for purposes of illustrating but not limiting the various examples described herein.

### DETAILED DESCRIPTION

The various techniques disclosed in this document may be used to detect milestones in a video recording of a procedure, such as a robot-assisted surgical procedure, using a multi-task learning framework for spatial context analysis and procedure milestone analysis. The multi-task learning framework may recognize a spatial environment context associated with procedure milestones which may improve the analysis performed by a neural network model and may provide a procedure evaluation output. The procedure evaluation output may be instructive to an operator who performed the procedure, a trainer or proctor, and/or a process or system architect. For example, recognizing key moments within a video of a surgical procedure may provide concise and meaningful feedback to surgeons. The described systems may allow for automated detection of precise surgical milestone events and may provide feedback using a machine learning algorithm. Detection of key milestone events may be complicated by a variety of factors. For example, imaging data may be limited because the milestone events may be visible for only a few seconds and in some procedures may not be achieved at all. Simple binary classifiers (e.g., milestone achieved or not achieved) may not provide adequate context in the case of failure to achieve a milestone. Providing temporal and spatial information associated with a failure to achieve a surgical milestone may be more constructive to a clinician than a binary classifier.

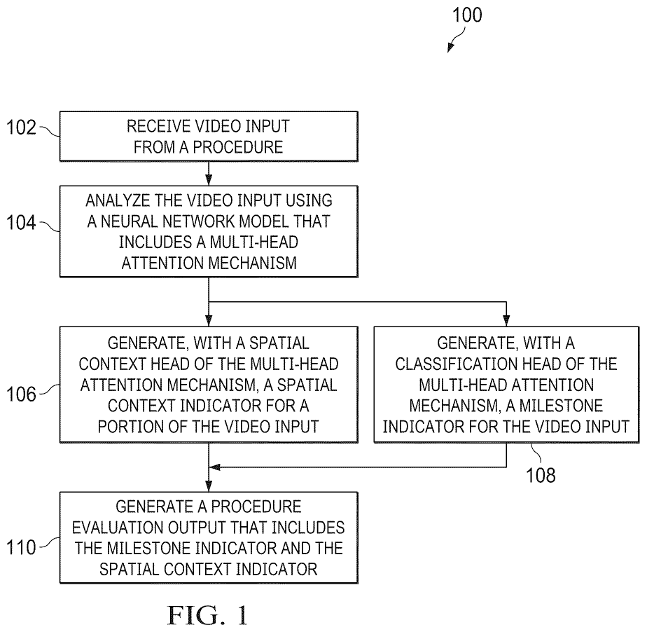

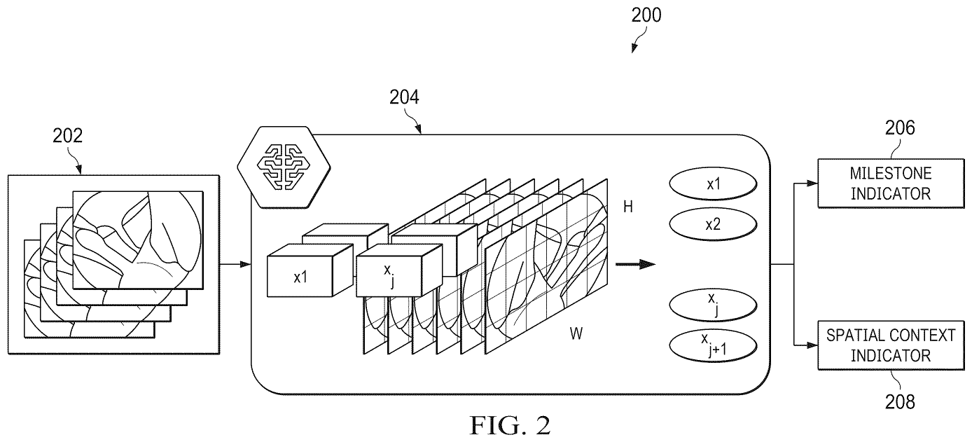

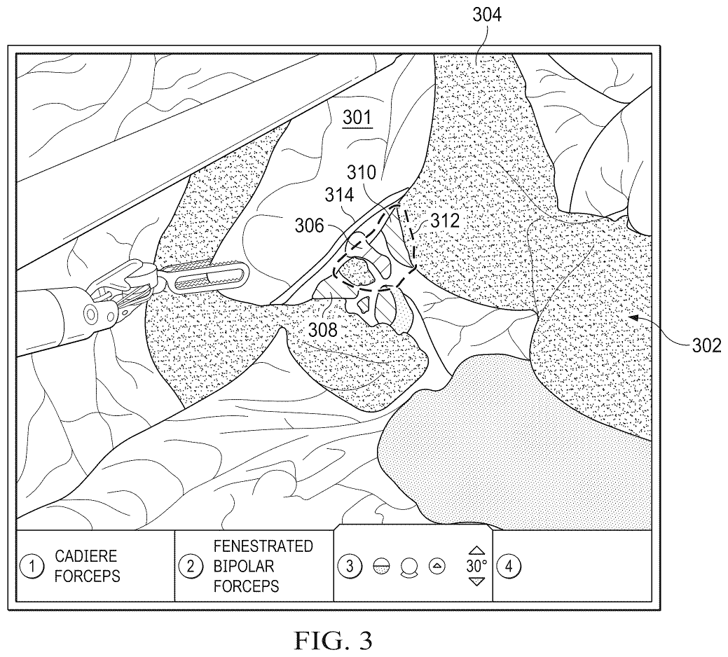

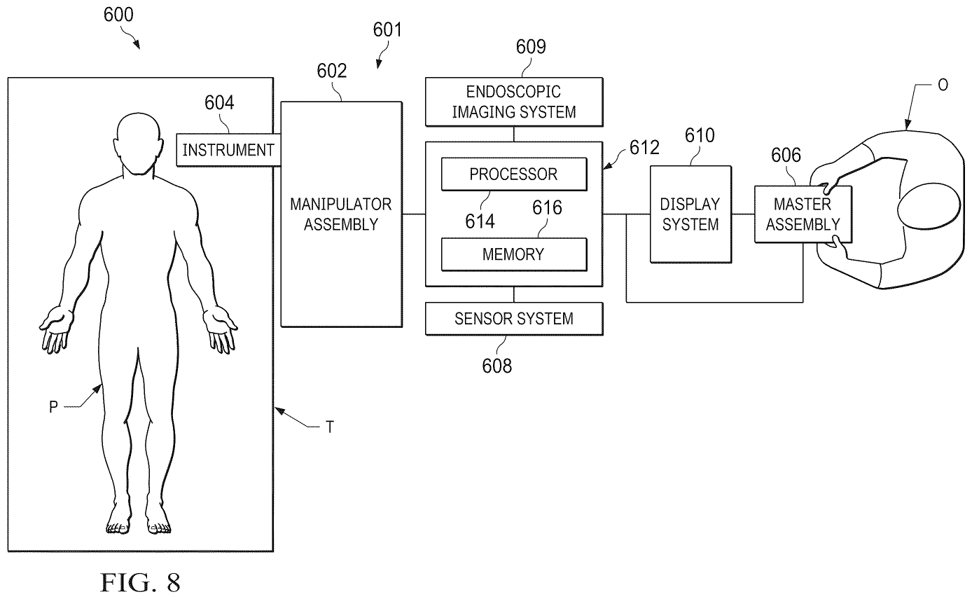

FIG. 1 illustrates a flowchart describing a method 100 for evaluating a procedure using a neural network model in accordance with some aspects of the present disclosure. The method 100 is illustrated as a set of operations or processes. The processes may be performed in the same or in a different order than the order shown in FIG. 1. One or more of the illustrated processes may be omitted in some examples of the method 100. Additionally, one or more processes that are not expressly illustrated in the flowchart may be included before, after, in between, or as part of the illustrated processes. In some examples, one or more of the processes of the flowchart may be implemented, at least in part, by a control system (e.g., the control system 612 of FIG. 8) executing code stored on non-transitory, tangible, machine-readable media that when run by one or more processors (e.g., the one or more processors of the control system 612) may cause the one or more processors to perform one or more of the processes. The method 100 will be described with reference to FIGS. 2 and 3. FIG. 2 illustrates a milestone detection workflow 200 including a neural network model. FIG. 3 illustrates a portion of a procedure evaluation output including an image frame from a video input with a spatial context indicator at a milestone event of the procedure.

At a process 102, a video input is received. The video input may be a video recorded, for example, by a laparoscope or endoscope inserted into a patient anatomy during a medical procedure. In some examples, a video of a medical procedure may be discretized as a sequence of framed images. The image frame rate may be based on one or more milestone definitions associated with the procedure. Different types of procedures or clinical cases may have different milestones and, accordingly, different image frame rates. A milestone definition may include a duration of time that an anatomic environment associated with the procedure milestone event is visible in the video. For examples, if an anatomic spatial environment (e.g., a configuration of anatomic structures and/or instruments) associated with a surgical milestone event is generally visible in a camera image for a short time, the image rate may be set to capture the short time duration that the surgical milestone is visible. The number of images frames comprising a video input may be selected to provide sufficient captured temporal information to understand the medical operation. For example, the number of image frames may be selected to capture actions or events in the medical procedure that may be associated with procedure milestones. As shown in FIG. 2, a video input 202 may include a plurality of discretized video frame images from a recorded video of a procedure. In some examples, the video input 202 includes video-only surgical data.

At a process 104, the video input may be analyzed using a neural network model that includes a multi-head attention mechanism. More specifically, the multi-head attention mechanism may include a spatial context head for performing spatial context analysis and a classification head for performing milestone event analysis. The neural network model may be trained to recognize both spatial locations of various anatomic structures as well as the achievement of multiple different criteria associated with one or more milestone events. The criteria may be associated with milestone events of the recorded procedure. The multi-task or multi-head framework may allow anatomical structures and milestone criteria to be learned simultaneously and may provide context for each other. This may reduce the total amount of data required to learn to recognize the criteria by providing an additional supervisory signal. The neural network model may take the sequential images of the video input recorded during a surgery in a laparoscopic view and may use them to model and predict milestone achievement status. In some examples, the neural network model includes spatial and temporal attention mechanisms which perform as an encoder to learn the features that represent the possible locations and relative positions of various anatomic organs, structures, and (optionally) instruments. The locations and position of organs and structures can be used to infer or otherwise understand the key or critical moments in the surgical procedure. The multiple task nature of the neural network model may be used to disentangle spatial-temporal correlations in the scenes that describe the physical process of the surgical procedure.

In a training phase, the neural network model may receive training data in the form of surgical video frames with paired annotations including segmentation masks associated with anatomic structures in the video frames and labels indicating milestone events. The labels may include absolute and/or relative arrangements of organs or other anatomic structures associated with milestone events. The multi-head attention mechanism may allow the training on milestone recognition and spatial segmentation to be conducted simultaneously. In this example, two major loss functions may be combined with other different regularized terms to optimize the learning process. Although the multi-head attention mechanism may be used to train the neural network model with temporal and spatial information simultaneously or in a synchronized manner, in alternative examples, asynchronized training strategies may be used. In those solutions, other types of consistency could be achieved without pairing the milestone label and spatial segmentation mask.

The trained neural network may be used at the process 104 to analyze video input data. For each sequential input, the spatial features of the image may be compressed into a compact feature vector that represents the image. More specifically, the neural network model takes the numeric operations over the sequential inputs and converts them into the compact feature vector representing the input. The multi-head attention mechanism of the neural network is applied to disentangle spatial and temporal correlations to mine out the representative semantics of a surgical event or action. The model may consider the high correlation between the two tasks due to the overlapped spatial context involved. The attention mechanism may be a selective weighting technology that applies different weights to emphasize different parts of the image information, resulting in a compressed representation that fulfills a task requirement. The attention mechanism may have weighting capabilities on spatial and temporal dimensions. The spatial and temporal weightings may be correlated. In some examples, the neural network model may be a transformer model that develops contextual learning by tracking relationships or dependencies in sequential data inputs, such as image frames of a video input. The attention mechanism may guide spatial visualization and milestone detection results, with the neural network model processing both tasks, at the same time, in one end-to-end framework. As shown in FIG. 2, a neural network model 204 includes a multi-head attention mechanism that includes a spatial context head and a classification head.

At a process 106, a spatial context indicator may be generated or predicted for all or some of the video frame images of the video input using the spatial context head of the multi-head attention mechanism. The spatial context head may use graphic analysis techniques to provide an anatomical spatial context prediction for an image frame. In some examples, the spatial context indicator may be a graphical mask generated using graphical segmentation techniques to partition pixels or voxels of a digital image into regions based, for example, on intensity, color, texture, or other characteristics or parameters. The graphical mask may, for example, include color-coded regions with each region corresponding to an anatomic organ or structure. The graphical mask may show the spatial locations of organs and structures relative to each other. In some examples the spatial context indicator may include a heatmap or other graphical representation of data values associated with attention. The heatmap may include a highlight or color to visualize the region of attention in the image. The heatmap may be computed from pre-defined anatomical rules but may be probabilistic in data-driven spatial-temporal correlation. The spatial context indicator may be displayed as an overlay or mask on the original frame image of the video input. As shown in FIG. 2, the neural network model 204 may generate a spatial context indicator 208.

As an example, FIG. 3 illustrates a spatial context indicator at a milestone event of a surgical procedure. An image frame 300 may be from a video input captured during a cholecystectomy procedure to surgically remove a gallbladder 301. In this example, the spatial context indicator may be a graphical mask 302 including a shaded mask region 304 that overlays a liver, a shaded mask region 306 that overlays a cystic artery, a shaded mask region 308 that overlays a cystic duct, and a shaded mask region 310 that overlays a common hepatic duct. The spatial visualization from anatomy segmentation, including the spatial context indicator, may enrich the user experience by directly revealing the clinic context of various steps and milestone events of the procedure. The neural network model (e.g., the neural network model 204) may be trained to recognize or predict when a milestone event of the cholecystectomy procedure, known as the “critical view of safety” (CVS), is achieved. Three criteria of CVS, as defined by the Society of Gastrointestinal and Endoscopic Surgeons, are highly defined by understanding the spatial layout and the visibility of the relevant anatomies. The three criteria required to achieve the CVS are as follows. A first criteria for recognizing the achievement of CVS is visual confirmation (e.g., based on spatial segmentation) that a hepatocystic triangle 312 is cleared of fat and fibrous tissue. The hepatocystic triangle may be defined as the triangle formed by the cystic duct, the common hepatic duct, and the inferior edge of the liver. A second criteria for recognizing the achievement of CVS is visual confirmation (e.g., based on spatial segmentation) that the lower one third of the gallbladder 301 is separated from the liver to expose the cystic plate 314. The cystic plate 314 is also known as liver bed of the gallbladder and lies in the gallbladder fossa. The third criteria for recognizing the achievement of CVS is visual confirmation (e.g., based on spatial segmentation) that two and only two structures (i.e., the cystic duct and the cystic artery) should be seen entering the gallbladder.

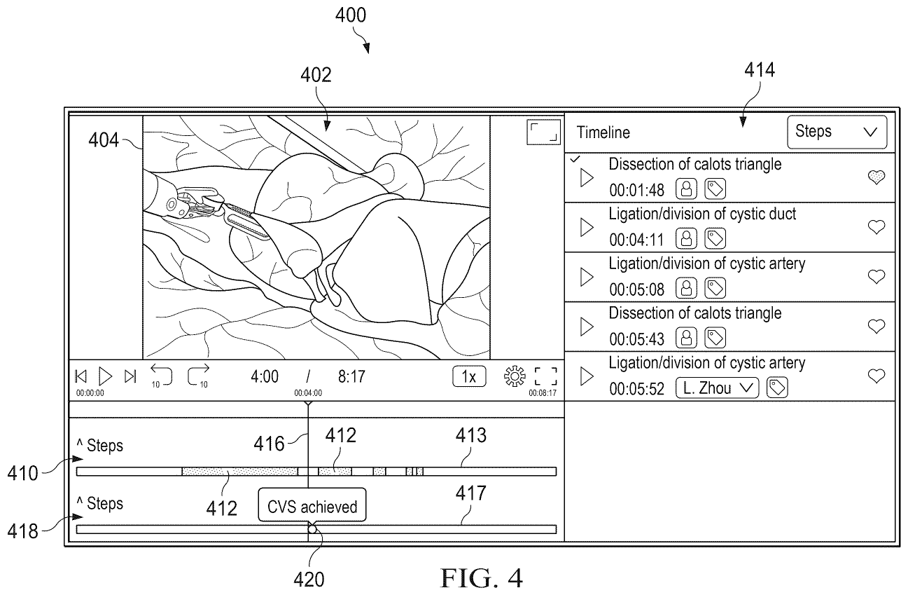

At a process 108, a milestone indicator may be generated or predicted for all or some of the video frame images of the video input using the classification head of the multi-head attention mechanism. The classification head may consider milestone event recognition as a multiple label classification problem. The output of the classification head may be a binary vector, with each entry of the label indicating the achievement status of a milestone criterion. A single milestone event may have multiple criteria that define the achievement status of the milestone event. Detection of the milestone event may be determined based on the developed spatial context information. In some examples, a milestone event may be detected only if spatial context criteria associated with the milestone event is recognized in the analyzed video input. Further, milestone event detection may be based on temporal considerations such as whether prerequisite criteria have occurred. As shown in FIG. 2, the neural network neural network 204 may generate a milestone indicator 206. With reference to FIG. 3, the three criteria of CVS may be highly defined by understanding the spatial layout and the visibility of the relevant anatomies. The neural network model may reference the spatial context indicator 302 and the various identified mask regions to determine if the three criteria of CVS have been met and thus if CVS has been achieved. The image frame 300 associated with the CVS may be marked, tagged, or otherwise flagged to record a milestone achievement status. The milestone indicator may include temporal indicator such as a time stamp or an event flag posted on a timeline of the procedure (See FIG. 4).

With reference again to FIG. 1, at a process 110, a procedure evaluation output may be generated, including the milestone indicator and the spatial context indicator. The procedure evaluation output may be in the form of a user interface that provides concise, meaningful feedback to clinician regarding the performed procedure and the achievement of milestone events. Providing both spatial and temporal context for the procedure evaluation of milestone achievement, may be more effective than simple binary (e.g., achieved/not achieved) feedback.

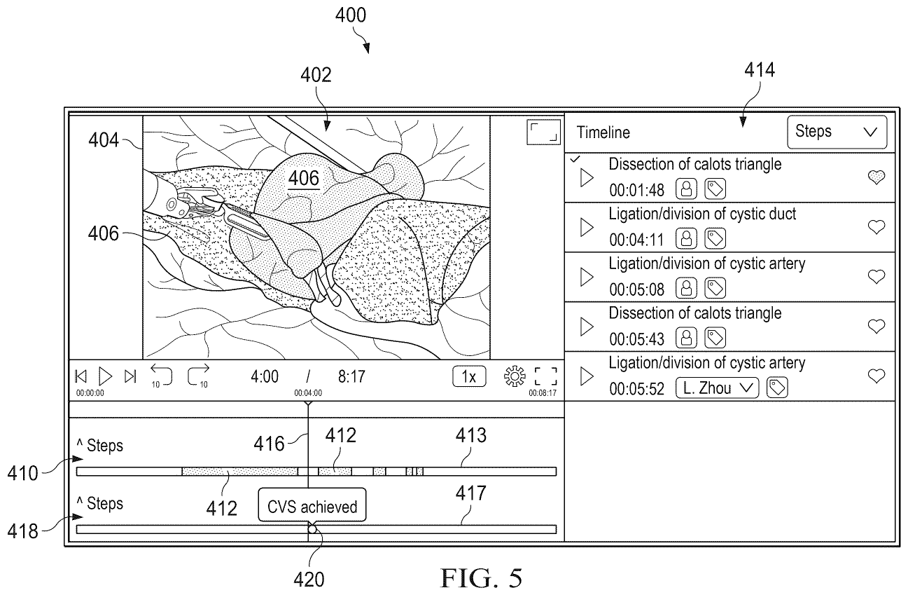

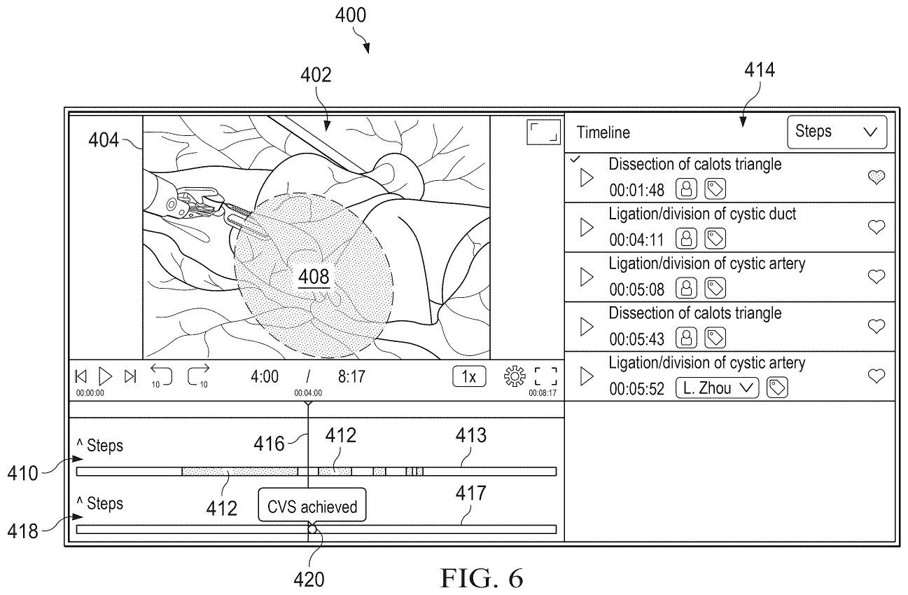

As shown in FIGS. 4-6, in some examples a procedure evaluation output may be a user interface 400 displayed on a display device. The user interface 400 may include an image portion or window 402 for displaying an image frame 404 of a video input. As shown in FIG. 4, the image frame 404 may be displayed without annotation or modification. As shown in FIG. 5, the image frame 404 may be displayed in the window 402 as an evaluated image with a spatial context indicator 406 in the form of a graphical segmentation mask overlaying the image frame 404. The graphical segmentation mask may include different colors, textures, shades, or other visibly different treatments to indicate different anatomic structures. As shown in FIG. 6, the image frame 404 may be displayed in the window 402 as an evaluated image with a spatial context indicator 408 in the form of a graphical attention mask overlaying the image frame 404. A user may toggle between graphical masks, or the display of the mask may be associated with a step of the procedure or a milestone event. Overlays and masking are examples of image modifications but other image modifications such as textual labels, boundary lines, graphic manipulation of the original image frame, or other modifications may be suitable to provide spatial context information.

The user interface 400 may also include a portion 410 that include markers 412 associated with steps of the procedure, arranged along a timeline. The timeline and the length of the markers 412 may indicate a duration of the step of the procedure, start and end times, intervals and other temporal information. Details of the steps of the procedure may be displayed in a portion 414 of the user interface 400. In this examples, five steps of the cholecystectomy procedure may be indicated by the markers 412 along a timeline or navigation bar 413 of the procedure and may be listed in a timeline menu in the portion 414. The timeline menu may include labels associated with discrete tasks of the procedure. A selector 416 may be a movable user interface tool, allowing a user to drag the selector 416 along the timeline to view the annotated or unannotated video frames of the procedure at the selected portion of the timeline or at a selected marker 412. The anatomies shown in the portion 402 correspond to the selected time.

The user interface 400 may also include a portion 418 that identifies milestone indicators 420 or other event flags of the procedure arranged along the timeline. In this example, the milestone indicator 420 may include an event flag with a textual description of the milestone event, “CVS achieved.” The selector 416 may be moved by the user along a timeline or navigation bar 417 to view the annotated or unannotated video frames of the procedure at the image frame in which the milestone event, namely the achievement of the CVS, is reached. The selector 416 and the milestone indicators 420 provide a video highlight function, allowing a user to check and review the milestone achievement status. The visualized anatomical context with graphical masks also aids in clinician review.

In some examples, the user interface 400 may include a detailed performance assessment and individual status and confidence scores for each milestone criterion. As described, achievement of milestone events may be divided into multiple criteria. Partial achievement of a milestone, or achievement of less than all criteria, may also be useful feedback to the clinician. The user interface 400 may indicate which criterion of a milestone event was not achieved. For example, in a case when the milestone is not achieved, it may be helpful to know if there was an anatomical structure, required to achieve the missing criterion, that was never visible within the procedure video. Anatomical structures which are essential to the surgery may be identified to a clinician via a user interface in later procedures. Providing graphical analysis when milestones are non-achieved allows the user interface to provide user warning and extra feedback to analyze those cases.

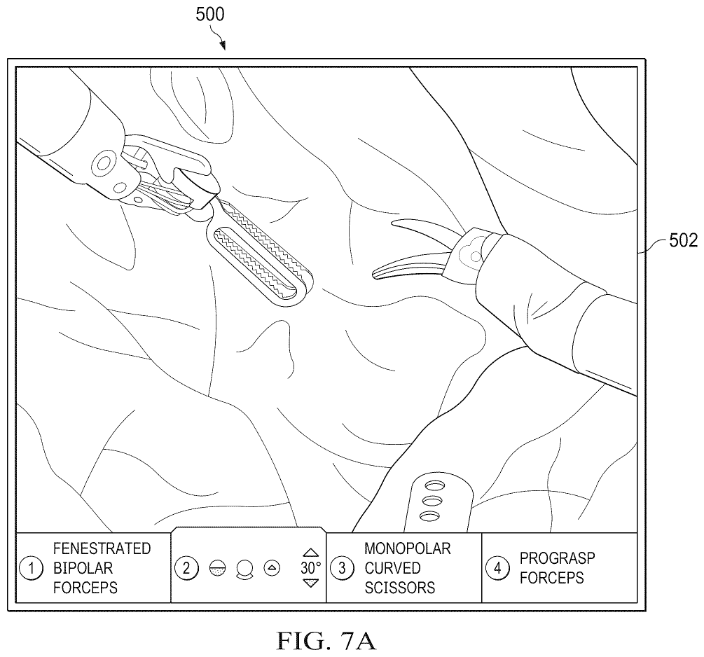

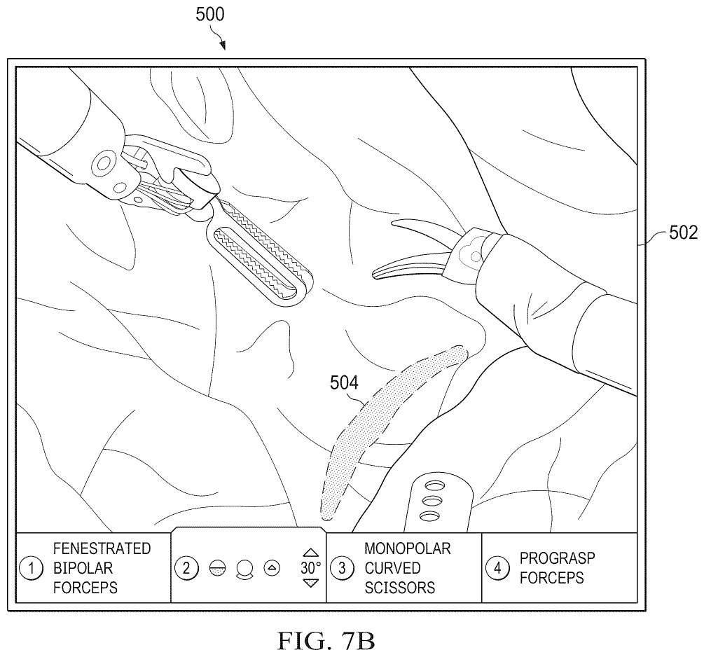

In other examples, a neural network model (e.g. the model 204) may be trained for spatial context determination and milestone event determination for other types of medical procedures. FIGS. 7A and 7B illustrate an image portion 500 of a user interface that may be displayed in a procedure evaluation output of a hysterectomy procedure. FIG. 7A illustrates an image frame 502 from of a video of a hysterectomy procedure. FIG. 7B illustrates the image frame 502 annotated to include a spatial context indicator 504 at a milestone event of the hysterectomy procedure. Using similar methods and systems as described above, a milestone event of a hysterectomy procedure, namely the detection of an embedded ureter prior to dissection of lymph nodes, may be identified and flagged. In this example, the spatial context indicator 504 may be a graphical mask that identifies or predicts the location of the embedded ureter. An event flag or other milestone indicator may be displayed on a timeline or navigation bar when this critical event of the hysterectomy procedure is achieved.

In some examples, the techniques of this disclosure may be used in an image-guided medical procedure performed with a robot-assisted medical system as shown in FIG. 8. FIG. 8 illustrates a robot-assisted medical system 600. The robot-assisted medical system 600 generally includes a manipulator assembly 602 for operating a medical instrument system 604 (including, for example, an elongate device) in performing various procedures on a patient P positioned on a table T in a surgical environment 601. The manipulator assembly 602 may be robot-assisted, non-assisted, or a hybrid robot-assisted and non-assisted assembly with select degrees of freedom of motion that may be motorized and/or robot-assisted and select degrees of freedom of motion that may be non-motorized and/or non-assisted. A master assembly 606, which may be inside or outside of the surgical environment 601, generally includes one or more control devices for controlling manipulator assembly 602. Manipulator assembly 602 supports medical instrument system 604 and may optionally include a plurality of actuators or motors that drive inputs on medical instrument system 604 in response to commands from a control system 612. The actuators may optionally include drive systems that when coupled to medical instrument system 604 may advance medical instrument system 604 into a naturally or surgically created anatomic orifice. Other drive systems may move the distal end of medical instrument system 604 in multiple degrees of freedom, which may include three degrees of linear motion (e.g., linear motion along the X, Y, Z Cartesian axes) and in three degrees of rotational motion (e.g., rotation about the X, Y, Z Cartesian axes). Additionally, the actuators can be used to actuate an articulable end effector of medical instrument system 604 for grasping tissue in the jaws of a biopsy device and/or the like.

Robot-assisted medical system 600 also includes a display system 610 for displaying an image or representation of the surgical site and medical instrument system 604 generated by a sensor system 608 and/or an endoscopic imaging system 609. Display system 610 and master assembly 606 may be oriented so operator O can control medical instrument system 604 and master assembly 606 with the perception of telepresence.

In some examples, medical instrument system 604 may include components for use in surgery, biopsy, ablation, illumination, irrigation, or suction. Optionally medical instrument system 604, together with sensor system 608 may be used to gather (e.g., measure) a set of data points corresponding to locations within anatomical passageways of a patient, such as patient P. In some examples, medical instrument system 604 may include components of the imaging system 609, which may include an imaging scope assembly or imaging instrument that records a concurrent or real-time image of a surgical site and provides the image to the operator or operator O through the display system 610. The concurrent image may be, for example, a two or three-dimensional image captured by an imaging instrument positioned within the surgical site. In some examples, the imaging system components that may be integrally or removably coupled to medical instrument system 604. However, in some examples, a separate endoscope, attached to a separate manipulator assembly may be used with medical instrument system 604 to image the surgical site. The imaging system 609 may be implemented as hardware, firmware, software or a combination thereof which interact with or are otherwise executed by one or more computer processors, which may include the processors of the control system 612.

The sensor system 608 may include a position/location sensor system (e.g., an electromagnetic (EM) sensor system) and/or a shape sensor system (e.g., an optical fiber shape sensor system) for determining the position, orientation, speed, velocity, pose, and/or shape of the medical instrument system 604. In some examples, the sensor system 608 includes a shape sensor. The shape sensor may include an optical fiber extending within and aligned with the medical instrument system 604 (e.g., an elongate device). In one example, the optical fiber has a diameter of approximately 200 um. In other examples, the dimensions may be larger or smaller. The optical fiber of the shape sensor forms a fiber optic bend sensor for determining the shape of the elongate device. In one alternative, optical fibers including Fiber Bragg Gratings (FBGs) are used to provide strain measurements in structures in one or more dimensions. Various systems and methods for monitoring the shape and relative position of an optical fiber in three dimensions are described in U.S. patent application Ser. No. 11/180,389 (filed Jul. 13, 2005) (disclosing “Fiber optic position and shape sensing device and method relating thereto”); U.S. patent application Ser. No. 12/047,056 (filed on Jul. 16, 2004) (disclosing “Fiber-optic shape and relative position sensing”); and U.S. Pat. No. 6,389,187 (filed on Jun. 17, 1998) (disclosing “Optical Fiber Bend Sensor”), which are all incorporated by reference herein in their entireties. Sensors in some examples may employ other suitable strain sensing techniques, such as Rayleigh scattering, Raman scattering, Brillouin scattering, and Fluorescence scattering. In some examples, the shape of the catheter may be determined using other techniques. For example, a history of the distal end pose of the elongate device can be used to reconstruct the shape of the elongate device over the interval of time.

Robot-assisted medical system 600 may also include control system 612. Control system 612 includes at least one memory 616 and at least one computer processor 614 for effecting control between medical instrument system 604, master assembly 606, sensor system 608, endoscopic imaging system 609, and display system 610. Control system 612 also includes programmed instructions (e.g., a non-transitory machine-readable medium storing the instructions) to implement some or all of the methods described in accordance with aspects disclosed herein, including instructions for providing information to display system 610.

Control system 612 may optionally further include a virtual visualization system to provide navigation assistance to operator O when controlling medical instrument system 604 during an image-guided surgical procedure. Virtual navigation using the virtual visualization system may be based upon reference to an acquired preoperative or intraoperative dataset of anatomical passageways. The virtual visualization system processes images of the surgical site imaged using imaging technology such as computerized tomography (CT), magnetic resonance imaging (MRI), fluoroscopy, thermography, ultrasound, optical coherence tomography (OCT), thermal imaging, impedance imaging, laser imaging, nanotube X-ray imaging, and/or the like.

The singular forms “a”, “an”, and “the” are intended to include the plural forms as well, unless the context indicates otherwise. And the terms “comprises,” “comprising,” “includes,” “has,” and the like specify the presence of stated features, steps, operations, elements, and/or components but do not preclude the presence or addition of one or more other features, steps, operations, elements, components, and/or groups. Components described as coupled may be electrically or mechanically directly coupled, or they may be indirectly coupled via one or more intermediate components. Components described as coupled may be directly or indirectly communicatively coupled. The auxiliary verb “may” likewise implies that a feature, step, operation, element, or component is optional.

In the description, specific details have been set forth describing some examples. Numerous specific details are set forth in order to provide a thorough understanding of the examples. It will be apparent, however, to one skilled in the art that some examples may be practiced without some or all of these specific details. The specific examples disclosed herein are meant to be illustrative but not limiting. One skilled in the art may realize other elements that, although not specifically described here, are within the scope and the spirit of this disclosure.

Elements described in detail with reference to one example, implementation, or application optionally may be included, whenever practical, in other examples, implementations, or applications in which they are not specifically shown or described. For example, if an element is described in detail with reference to one example and is not described with reference to a second example, the element may nevertheless be claimed as included in the second example. Thus, to avoid unnecessary repetition in the following description, one or more elements shown and described in association with one example, implementation, or application may be incorporated into other examples, implementations, or aspects unless specifically described otherwise, unless the one or more elements would make an example or implementation non-functional, or unless two or more of the elements provide conflicting functions.

Any alterations and further modifications to the described devices, instruments, methods, and any further application of the principles of the present disclosure are fully contemplated as would normally occur to one skilled in the art to which the disclosure relates. In addition, dimensions provided herein are for specific examples and it is contemplated that different sizes, dimensions, and/or ratios may be utilized to implement the concepts of the present disclosure. To avoid needless descriptive repetition, one or more components or actions described in accordance with one illustrative example can be used or omitted as applicable from other illustrative examples. For the sake of brevity, the numerous iterations of these combinations will not be described separately. For simplicity, in some instances the same reference numbers are used throughout the drawings to refer to the same or like parts.

The systems and methods described herein may be suited for navigation and treatment of anatomic tissues, via natural or surgically created connected passageways, in any of a variety of anatomic systems, including the lung, colon, the intestines, the kidneys and kidney calices, the brain, the heart, the circulatory system including vasculature, and/or the like. Although some of the examples described herein refer to surgical procedures or instruments, or medical procedures and medical instruments, the techniques disclosed apply to non-medical procedures and non-medical instruments. For example, the instruments, systems, and methods described herein may be used for non-medical purposes including industrial uses, general robotic uses, and sensing or manipulating non-tissue work pieces. Other example applications involve cosmetic improvements, imaging of human or animal anatomy, gathering data from human or animal anatomy, and training medical or non-medical personnel. Additional example applications include use for procedures on tissue removed from human or animal anatomies (without return to a human or animal anatomy) and performing procedures on human or animal cadavers. Further, these techniques can also be used for surgical and nonsurgical medical treatment or diagnosis procedures.

Further, although some of the examples presented in this disclosure discuss robotic-assisted systems or remotely operable systems, the techniques disclosed are also applicable to computer-assisted systems that are directly and manually moved by operators, in part or in whole.

Additionally, one or more elements in examples of this disclosure may be implemented in software to execute on a processor of a computer system such as a control processing system. When implemented in software, the elements of the examples of the present disclosure are essentially the code segments to perform the necessary tasks. The program or code segments can be stored in a processor readable storage medium (e.g., a non-transitory storage medium) or device that may have been downloaded by way of a computer data signal embodied in a carrier wave over a transmission medium or a communication link. The processor readable storage device may include any medium that can store information including an optical medium, semiconductor medium, and magnetic medium. Processor readable storage device examples include an electronic circuit, a semiconductor device, a semiconductor memory device, a read only memory (ROM), a flash memory, an erasable programmable read only memory (EPROM); a floppy diskette, a CD-ROM, an optical disk, a hard disk, or other storage device. The code segments may be downloaded via computer networks such as the Internet, Intranet, etc. Any of a wide variety of centralized or distributed data processing architectures may be employed. Programmed instructions may be implemented as a number of separate programs or subroutines, or they may be integrated into a number of other aspects of the systems described herein. In some examples, the control system may support wireless communication protocols such as Bluetooth, Infrared Data Association (IrDA), HomeRF, IEEE 802.11, Digital Enhanced Cordless Telecommunications (DECT), ultra-wideband (UWB), ZigBee, and Wireless Telemetry.

A computer is a machine that follows programmed instructions to perform mathematical or logical functions on input information to produce processed output information. A computer includes a logic unit that performs the mathematical or logical functions, and memory that stores the programmed instructions, the input information, and the output information. The term “computer” and similar terms, such as “processor” or “controller” or “control system”, are analogous.

Note that the processes and displays presented may not inherently be related to any particular computer or other apparatus, and various systems may be used with programs in accordance with the teachings herein. The required structure for a variety of the systems discussed above will appear as elements in the claims. In addition, the examples of the present disclosure are not described with reference to any particular programming language. It will be appreciated that a variety of programming languages may be used to implement the teachings of the present disclosure as described herein.

While certain example examples of the present disclosure have been described and shown in the accompanying drawings, it is to be understood that such examples are merely illustrative of and not restrictive to the broad disclosed concepts, and that the examples of the present disclosure are not limited to the specific constructions and arrangements shown and described, since various other modifications may occur to those ordinarily skilled in the art.

1. A method for detecting procedure milestone events with a spatial context, the method comprising:
receiving a video input including a plurality of video frame images of a procedure;
analyzing the video input using a neural network model that includes a multi-head attention mechanism;
generating, with a spatial context head of the multi-head attention mechanism, a spatial context indicator for at least a portion of the plurality of video frame images;
generating, with a classification head of the multi-head attention mechanism, a milestone indicator for at least one of the plurality of video frame images of the plurality of video frame images; and
generating a procedure evaluation output that includes the milestone indicator and the spatial context indicator.

2. The method of claim 1, wherein a frame rate for the plurality of video frame images is based on a milestone definition.

3. The method of claim 1, wherein analyzing the video input using the neural network model includes generating a compact feature vector to represent the video input.

4. The method of claim 1, wherein analyzing the video input using the neural network model includes using the multi-head attention mechanism to apply a spatial weighting and a temporal weighting to the video input.

5. (canceled)

6. The method of claim 1, wherein the spatial context indicator includes a graphical mask for at least the portion of the plurality of video frame images.

7. The method of claim 6, wherein the graphical mask includes a heatmap associated with a parameter of the spatial context head of the multi-head attention mechanism.

8. The method of claim 1, wherein the milestone indicator includes a binary vector indicating a milestone achievement status.

9. (canceled)

10. The method of claim 1, wherein the procedure evaluation output includes:
a first display portion including a first evaluated image comprising a first frame of the plurality of video frame images and the spatial context indicator and
a second display portion including a navigation bar user interface manipulatable to select among a plurality of evaluated images, including the first evaluated image.

11. The method of claim 10, wherein the navigation bar user interface further includes an event flag associated with the milestone indicator, wherein a second evaluated image at the event flag includes a second frame of the plurality of video frame images and the spatial context indicator for the second frame includes a milestone achievement associated with the milestone indicator.

12. The method of claim 10, wherein the procedure evaluation output further includes a third display portion including a timeline menu, wherein the timeline menu includes a plurality of labels with each label associated with a discrete task of the procedure.

13. A system for detecting procedure milestone events with a spatial context, the system comprising:
a memory configured to store a neural network model; and
a processor coupled to the memory, the processor configured to:
receive a video input including a plurality of video frame images of a procedure;
analyze the video input using a neural network model that includes a multi-head attention mechanism;
generate, with a spatial context head of the multi-head attention mechanism, a spatial context indicator for at least a portion of the plurality of video frame images;
generate, with a classification head of the multi-head attention mechanism, a milestone indicator for at least one of the plurality of video frame images of the plurality of video frame images; and
generate a procedure evaluation output that includes the milestone indicator and the spatial context indicator.

14. The system of claim 13, wherein a frame rate for the plurality of video frame images is based on a milestone definition.

15. The system of claim 13, wherein analyzing the video input using the neural network model includes generating a compact feature vector to represent the video input.

16. The system of claim 13, wherein analyzing the video input using the neural network model includes using the multi-head attention mechanism to apply a spatial weighting and a temporal weighting to the video input.

17. (canceled)

18. The system of claim 13, wherein the spatial context indicator includes a graphical mask for at least the portion of the plurality of video frame images.

19. The system of claim 18, wherein the graphical mask includes a heatmap associated with a parameter of the spatial context head of the multi-head attention mechanism.

20. The system of claim 13, wherein the milestone indicator includes a binary vector indicating a milestone achievement status.

21. The system of claim 13, wherein the procedure evaluation output includes:
a first display portion including a first evaluated image comprising a first frame of the plurality of video frame images and the spatial context indicator and
a second display portion including a navigation bar user interface manipulatable to select among a plurality of evaluated images, including the first evaluated image.

22. The system of claim 21, wherein the navigation bar user interface further includes an event flag associated with the milestone indicator, wherein a second evaluated image at the event flag includes a second frame of the plurality of video frame images and the spatial context indicator for the second frame includes a milestone achievement associated with the milestone indicator.

23. The system of claim 21, wherein the procedure evaluation output further includes a third display portion including a timeline menu, wherein the timeline menu includes a plurality of labels with each label associated with a discrete task of the procedure.

24-35. (canceled)
